(19) United States
(12) Patent Application Publication
(10) Pub. No.: US 2020/0016840 A1
(43) Pub. Date: Jan. 16, 2020

(54) CONTINUOUS FILAMENT FEEDING FOR ADDITIVE MANUFACTURING

(71) Applicant: D. Swarovski KG, Wattens (AT)

(72) Inventors: Arik Bracha, Tel-Aviv (IL); Eran Gal-or, Kfar-Saba (IL)

(21) Appl. No.: 16/489,521

(22) PCT Filed: Feb. 26, 2018
(86) PCT No.: PCT/IB2018/051179

§ 371 Date: Aug. 28, 2019

Related U.S. Application Data
(60) Provisional application No. 62/467,153, filed on Mar. 5, 2017.

(51) Int. Cl. B29C 64/393; B29C 64/118; B29C 64/209; B33Y 10/00; B33Y 30/00; B33Y 50/02

(52) U.S. Cl. CPC B29C 64/393; B29C 64/118; B33Y 50/02; B33Y 10/00; B33Y 30/00; B29C 64/209

(57) ABSTRACT

A continuous 3D printing system, comprising a loading station no loaded with printing materials; a detection station; wherein the detection station is configured to detect the end of a first printing material loaded by the loading station; a bonding station configured to connect the first printing materials to a second printing material loaded by the loading station upon receiving a signal from the detection station; a printing head configured to print a 3D model; a feeding mechanism configured to feed printing material into the printing head; and a substrate on which the 3D printed model is printed.

### FIELD OF THE INVENTION

The present invention generally relates to printing systems and specifically to a 3D printing system enabling continuous printing material feeding.

### CROSS-REFERENCE TO RELATED PATENT APPLICATIONS

This patent application claims priority from and is related to U.S. Provisional Patent Application Ser. No. 62/467,153, filed Mar. 5, 2017, this U.S. Provisional Patent Application incorporated by reference in its entirety herein.

### BACKGROUND

3D printing or Additive Manufacturing (AM), Fuse Depositing Modeling (FDM) and Fused Filament Fabrication (FFT) refer to any of the various processes for printing a three-dimensional object. Primarily additive processes are used, in which successive layers of material are laid down under computer control. These objects can be of almost any shape or geometry, and are produced from a 3D model or other electronic data source. Different types of 3D printers were developed over the years, such as 3D FDM (Fused Deposition Modeling) extrusion printers. 3D FDM extrusion printers are mostly based on melting a filament, e.g. plastics, in a printer head.

The FDM/FFF printing process requires continuous printing material feeding.

While printing with printing materials, such as, glass, metal, plastic, ceramic, etc. if the printing material flow is not continuous, cracks and air gaps may appear in the printed part while printed. Such air gaps prevent the printed part from being sealed to liquid and reduce its strength.

Moreover, while printing, the printing head often has to stop printing at point “A” and continue printing in point “B”. In order to enable the printing head to move from point “A” to “B”, the printing system retracts the printing material so as to avoid oozing (printing material leakage). If the printing material is not continuous, such retraction sometimes cannot be performed because the printing material may no longer pass through the printing material's feeding mechanism.

Sometimes, it is required to switch between a number of printing materials, e.g., different glass colors, different glass materials, different metal materials or even switching from glass to metal while printing the same part.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic front view of a continuous 3D printing system according to embodiments of the invention;

FIG. 2 is an enlargement of detail A of FIG. 1 showing the rods which are being bonded by the bonding station;

FIG. 3 is a side perspective view of the system of FIG. 1 according to embodiments of the present invention;

FIG. 3A is a side perspective view of an exemplary embodiment of the 3D printing system of FIG. 1 comprising an arc welding station according to embodiments of the present invention;

FIG. 4 is a schematic view of an alternative cassette;

FIG. 5 shows a schematic view of an alternative loading station; and

FIG. 6 is an enlargement of detail B of FIG. 5 showing the shutter mechanism and the shutter door.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a system for continuous 3D printing of glass, metal, plastic, ceramic or any other printing material known in the art. Throughout the description, these materials may be referred to as printing material(s).

While printing with printing materials, such as, glass, metal, etc. if the printing material flow is not continuous, cracks and air gaps may appear in the printed part while printed. Such air gaps will prevent the printed part from being sealed to liquid and reduce its strength.

Moreover, while printing, the printing head often has to stop printing at point “A” and continue printing at point “B”. In order to enable the printing head to move from point “A” to “B”, the printing system's feeding mechanism retracts the printing material so as to avoid oozing (printing material's leakage). If the printing material is not continuous, e.g. rods, such retraction sometimes cannot be performed because the printing material may already have passed the feeding mechanism.

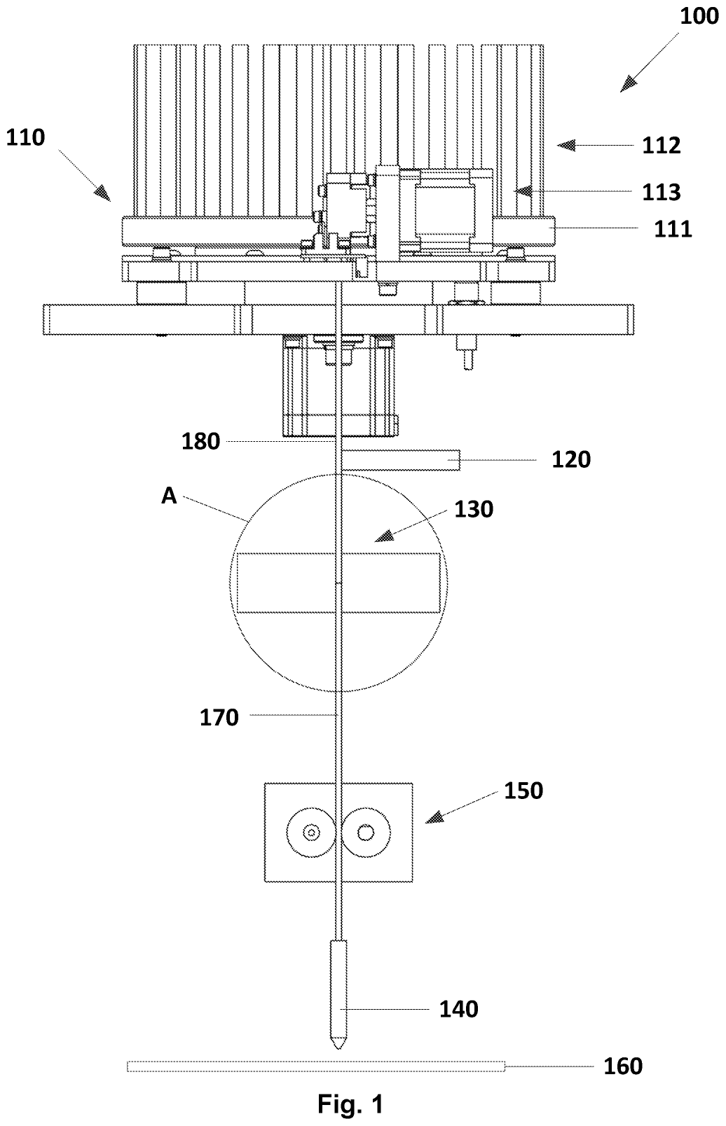

FIG. 1 is a schematic front view of the continuous 3D printing system 100 according to embodiments of the invention, comprising: a loading station 110 for loading printing material, a detection station 120 for detecting the presence/end of the printing material, a bonding station 130 for connecting one printing material to the other, a printing head (nozzle) 140 for printing the 3D model, a feeding mechanism 150 for feeding the printing material into the printing head 140 and a substrate/plate 160 on which the printed model is printed.

The printing material may be provided as rods, spool or any other form known in the art.

For the purpose of explanation, the printing material is presented as rods.

It will be appreciated that the system 100 is not limited to receive rods.

The detection station 120 may comprise an optical sensor, capacitive sensing, a mechanical switch, etc. for detecting the presence/end of the printing material and forwarding a corresponding indication to the loading station 110.

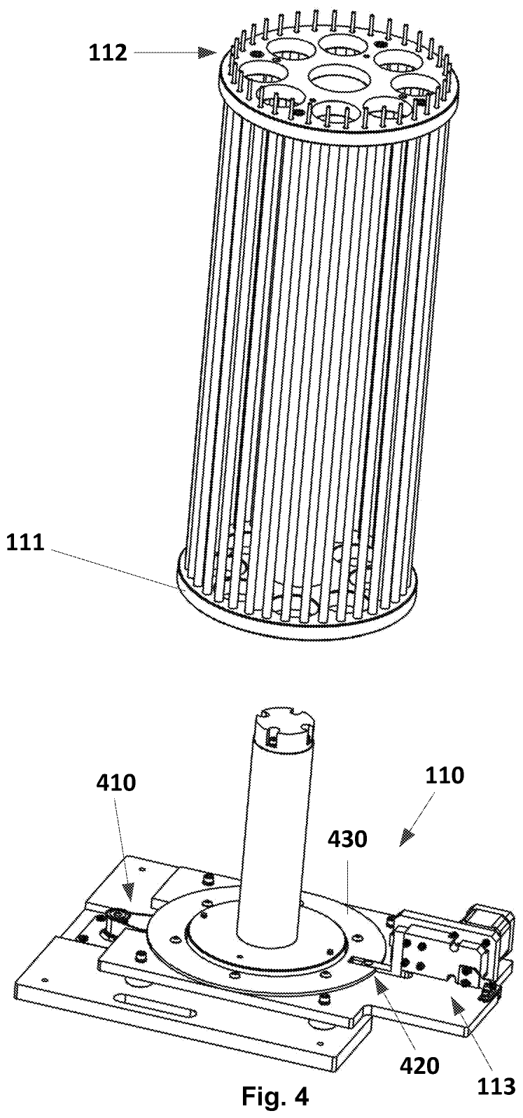

According to embodiments of the invention, the system may further comprise a fixed cassette 111 to which printing material rods 112 are loaded. Alternatively, the cassette 111 may be replaced as a whole with a new loaded cassette as presented in FIG. 4.

The cassette may be loaded with rods of the same material, different materials or same material with different colors.

The loading station 110 comprises a rotation mechanism (410 of FIG. 4) such as DC servo motor, pneumatic actuator, step motor, etc. intended to rotate the cassette, regardless of whether it is fixed or not, as necessary for aligning the next rod with the passage towards the detection station (not shown).

While the rotating cassette 111 rotates, the rods are sliding on a flat surface (430 of FIG. 4) having a hole covered by a shutter door (420 of FIG. 4).

The loading station 110 also comprises a shutter mechanism 113 comprising an actuator such as a step motor, DC servo motor, pneumatic actuator, solenoid, etc. which is intended to open the shutter door (420 of FIG. 4), namely, the passage between the rods' cassette and the detection station 120 in response to a signal generated by the detection station 120.

According to embodiments of the invention, instead of a shutter and a shutter door, the system may comprise a shutter below the bottom of each rod and an actuator intended to open the necessary rod's shutter in response to a signal generated by the detection station 120.

When rod 170 progresses towards the printing head 140, the detection station 120 detects the rod's end and signals the shutter mechanism 113 (or the actuator intended to open the necessary rod's shutter) to allow the next rod 180 to pass towards the bonding station 130. The rods 170 and 180 progress together while passing through the bonding station 130 and are bonded together, thus forming continuous printing material (filament). According to embodiments of the present invention, the feeding mechanism 150 may pause the feeding process while rods 170 and 180 are bonded.

According to embodiments of the invention, the bonding station 130 may be an arc welding station, gas welding station, laser welding station, induction welding station or any other welding system capable of welding printing materials.

According to embodiments of the invention, the bonding station 130 may apply glue between the rods for connecting them.

According to embodiments of the invention, the rods may comprise glue in one end or both.

As mentioned above, the printing material may be provided as a spool. In such a case the cassette may comprise spools.

According to embodiments of the present invention, the detection station may detect a mark or a code mounted at the beginning of each rod or spool thus enabling to verify that a correct material and/or a genuine material is being fed. If an incorrect or not genuine material is fed, the detection station may send an alert, stop printing, etc.

The mark or code may be a barcode, QR code or any other code known in the art.

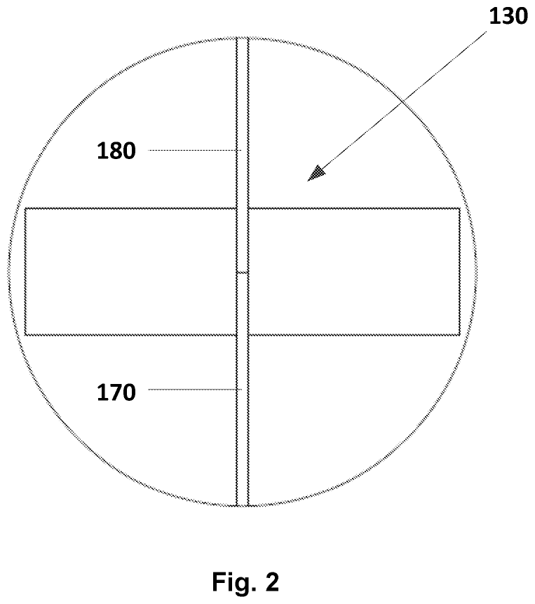

FIG. 2 is an enlargement of detail A of FIG. 1 showing rods 170 and 180 which are being bonded by the bonding station 130.

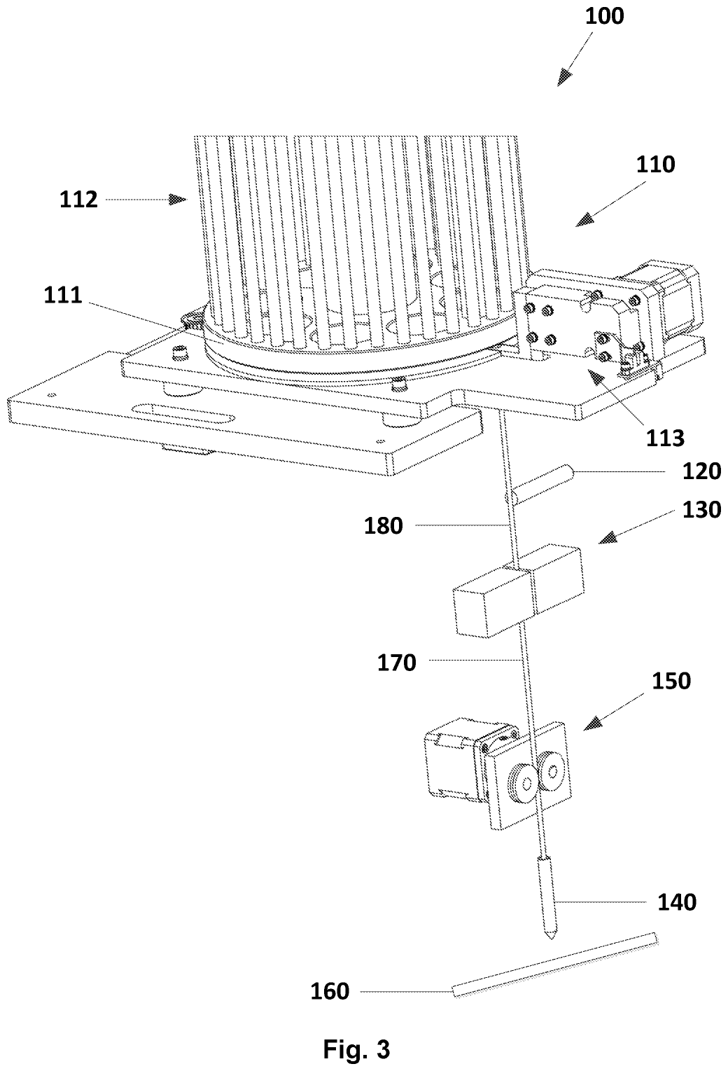

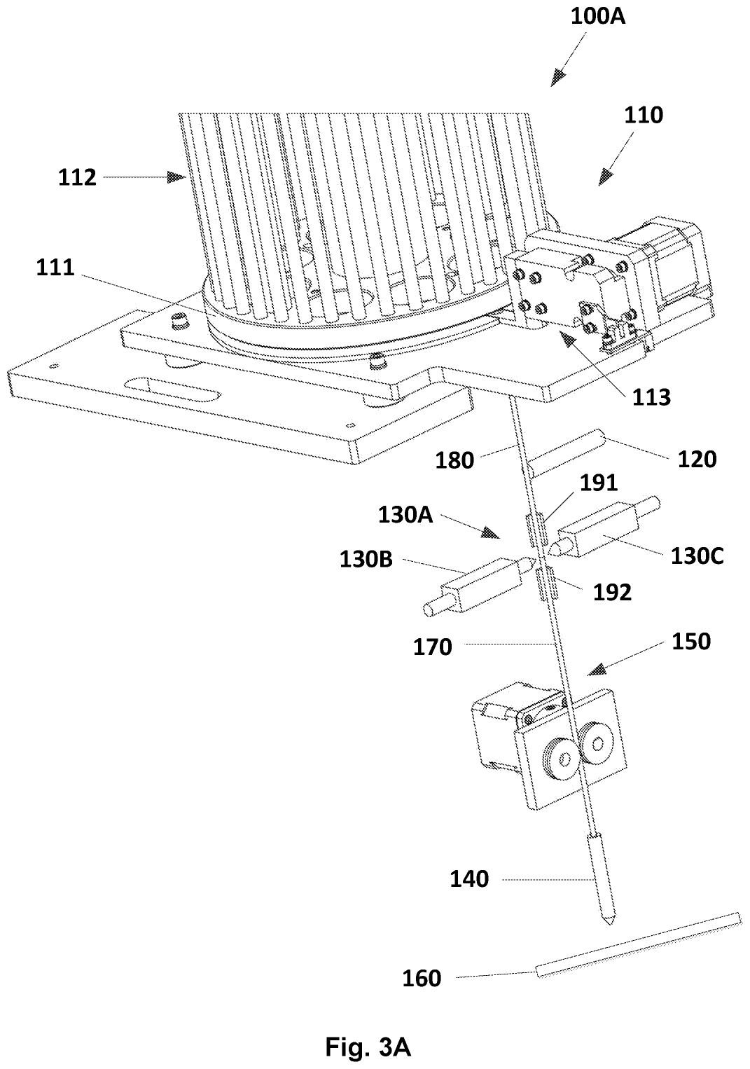

FIG. 3 is a side perspective view of the system 100 according to embodiments of the present invention.

FIG. 3A is a side perspective view of an exemplary embodiment 100A of the 3D printing system of FIG. 1 comprising an arc welding station according to embodiments of the present invention. The arc welding station 130A comprises at least two electrodes 130B and 130C mounted around the welding surface of the rods 170 and 180. A power unit (not shown) supplies voltage and current to the electrodes 130B and 130C for creating an electric arc between the electrodes 130B and 130C at the welding surface. According to embodiments of the present invention, a programmable control circuit varies the applied power over predefined time periods.

According to embodiments of the present invention, rods 170 and 180 may be aligned using alignment parts (e.g., 191 and 192).

According to embodiments of the invention, instead of the round cassette 111, the loading station may comprise a linear cassette moving on X plane, Y plane or XY plane.

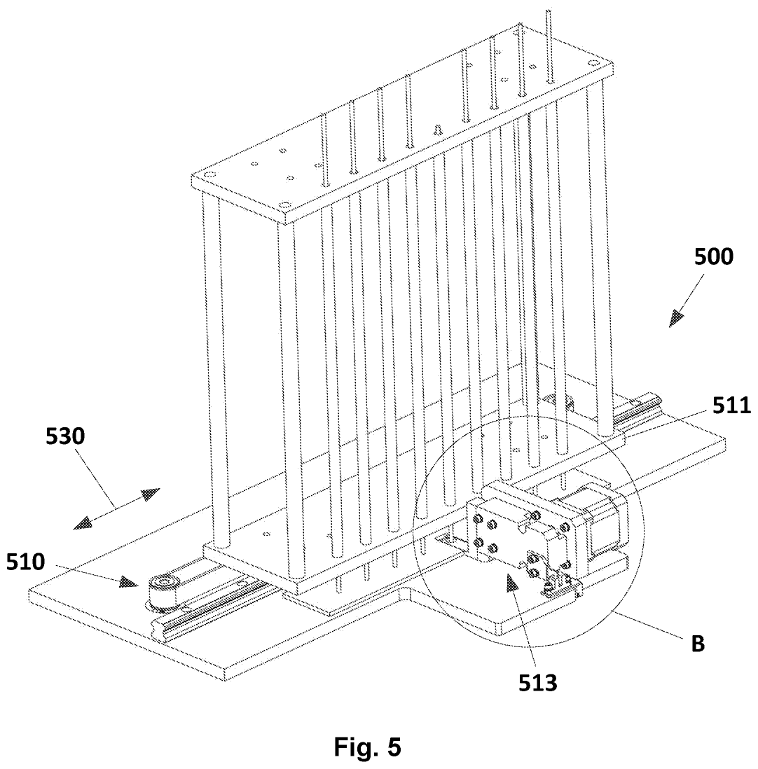

FIG. 5 shows a schematic view of an alternative loading station 500, comprising: a moving mechanism 510 for moving the cassette 511 in the directions of the dual head arrow 530 and a shutter mechanism 513 similar to shutter mechanism 113 described above.

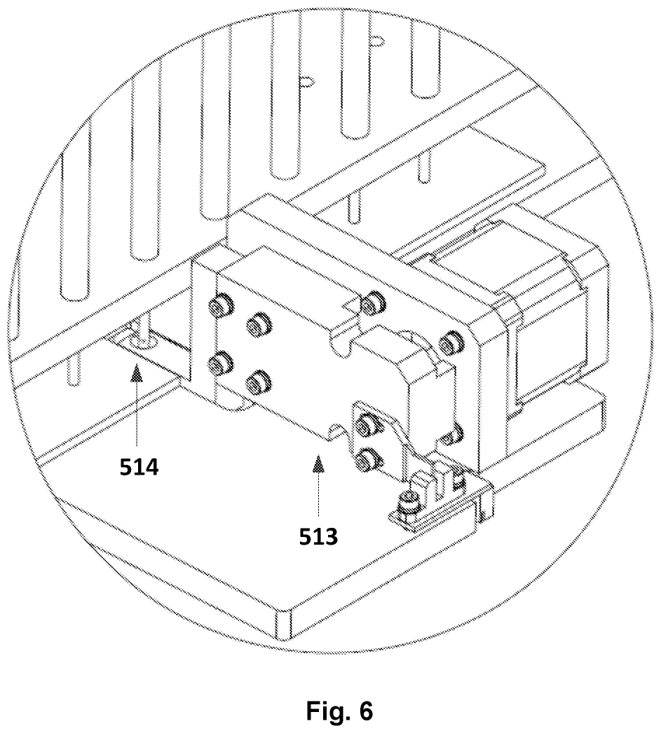

FIG. 6 is an enlargement of detail B of FIG. 5 showing the shutter mechanism 513 and the shutter door 514.

According to embodiments of the present invention, the printing system 100 may enable printing with different colors/materials. For example, when a new color has to be printed, the system may bond the new rod to the previous rod, dispose the previous rod on a disposing spot (e.g. the corner of the substrate) and continue printing with the new rod. Alternatively, the loading station may be loaded with the appropriate length of each color/material according to the printed part.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. A continuous 3D printing system, comprising:
a loading station loaded with printing materials;
a detection station;
wherein said detection station is configured to detect the end of a first printing material loaded by said loading station;
a bonding station configured to connect said first printing material to a second printing material loaded by said loading station upon receiving a signal from said detection station;
a printing head configured to print a 3D model;
a feeding mechanism configured to feed printing material into said printing head; and
a substrate on which said 30 printed model is printed.

2. The 3D printing system of claim 1, wherein said printing materials are formed as one of a rod and a spool.

3. The 3D printing system of claim 1, wherein said printing materials are one of glass, plastic, ceramic and metal.

4. The 3D printing system of claim 1, wherein said loading station comprises a cassette to which said printing materials are loaded.

5. The 3D printing system of claim 4, wherein said cassette comprises one of a fixed cassette and a replaceable cassette.

6. The 3D printing system of claim 4, wherein said cassette is loaded with one of the same printing materials, different printing materials and same printing materials having different colors.

7. The 3D printing system of claim 4, wherein said loading station further comprises a rotation mechanism configured to rotate said cassette.

8. The 3D printing system of claim 7, wherein said rotation mechanism comprises one of DC servo motor, step motor and pneumatic actuator.

9. The 3D printing system of claim 4, wherein said loading station further comprises a shutter mechanism and a shutter door; wherein said shutter mechanism is configured to open said shutter door upon receiving a signal from said detection station.

10. The 3D printing system of claim 9, wherein said shutter mechanism comprises one of a step motor, DC servo motor, pneumatic actuator and solenoid.

11. The 3D printing system of claim 1, wherein said detection station comprises one of an optical sensor, a capacitive sensor and a mechanical switch.

12. The 3D printing system of claim 1, wherein said bonding station comprises one of an arc welding station, a gas welding station, a laser welding station, an induction welding station and glue bonding station.

13. The 3D printing system of claim 1, wherein said bonding station comprises an arc welding station comprising a plurality of electrodes mounted around the welding surface of said printing material; the 3D printing system further comprises a power unit configured to supply voltage and current to said plurality of electrodes for creating an electric arc between said electrodes at the welding surface.

14. The 3D printing system of claim 4, wherein said loading station further comprises a moving mechanism configured to move said cassette linearly.

15. The 3D printing system of claim 1, wherein said first and second printing materials comprises one of a code and a mark; and wherein said detection station is configured to verify that said first and second printing materials are at least one of correct and genuine printing materials.

16. The 3D printing system of claim 1, wherein said printing materials comprise glue on at least one end thereof

17. The 3D printing system of claim 1, further comprising two aligning parts configured to align said first printing material with said second printing material.

18. A method of continuous 3D printing, comprising:
while printing, detecting by a detection station the end of a first printing material;
sending by said detection station a signal to a loading station thereby enabling a second printing material to progress towards said first printing material;
sending by said detection station a signal to a bonding station thereby connecting said first printing material to said second printed material.

19-33. (canceled)

34. The method of claim 18, wherein said first and second printing materials comprise one of a code and a mark; and wherein said method further comprises:
detecting, by said detection station, that said first and second printing materials are at least one of correct and genuine printing materials; and
wherein upon said detecting, the method further comprises:
at least one of alerting and stopping said printing.

35. (canceled)

36. (canceled)

37. The method of claim 18, further comprising aligning said first printing material with said second printing material.
